(19) United States
(12) Patent Application Publication
(10) Pub. No.: US 2026/0269361 A1
(43) Pub. Date: Sep. 10, 2026

(54) BATTERY COOLING DEVICE

(71) Applicants: HYUNDAI MOTOR COMPANY, SEOUL (KR); KIA CORPORATION, SEOUL (KR)

(72) Inventors: Gun Goo Lee, Hwaseong-si (KR); Jeong Won Cho, Hwaseong-si (KR)

(73) Assignees: HYUNDAI MOTOR COMPANY, SEOUL (KR); KIA CORPORATION, SEOUL (KR)

(21) Appl. No.: 19/303,297

(22) Filed: Aug. 18, 2025

(30) Foreign Application Priority Data
Mar. 10, 2025 (KR) 10-2025-0030299

(51) Int. Cl. H01M 10/6552; H01M 10/613; H01M 10/617; H01M 10/6557; H01M 10/6569; H01M 50/204

(52) U.S. Cl. CPC H01M 10/6552; H01M 10/613; H01M 10/617; H01M 10/6557; H01M 10/6569; H01M 50/204

(57) ABSTRACT

Disclosed is a battery cooling device. The battery cooling device includes a pulsating heat pipe, wherein the pulsating heat pipe is manufactured to have a structure in which a vertical channel performing a heat absorption function and a horizontal channel performing a condensation function form a T-shaped passage to increase the surface area of the horizontal channel. The horizontal channel may be arranged below at least one of two battery cells. The battery cells may be selected from a plurality of battery cells stacked having a predetermined number. The plurality of battery cells are stacked with a surface pressure pad disposed between at least two of the plurality of battery cells to evenly cool the battery cells.

### CROSS-REFERENCE TO RELATED APPLICATION(S)

This application claims, under 35 U.S.C. § 119(a), the benefit of and priority to Korean Patent Application No. 10-2025-0030299, filed on Mar. 10, 2025, the entire contents of which are incorporated herein by reference.

### TECHNICAL FIELD

The present disclosure relates to a battery cooling device. More particularly, the present disclosure relates to a battery cooling device configured to cool a battery using a pulsating heat pipe capable of heat absorption and heat dissipation.

### BACKGROUND

Generally, the thermal conductivity of a battery cell is much lower than that of a metal, so even in a case where one side surface or opposite side surfaces of the battery cell are cooled using a cooling channel through which cooling water flows, a temperature difference between an area adjacent to the cooling channel and an area not adjacent to the cooling channel in the battery cell is created, which reduces the cooling effect.

In order to address the temperature difference, a battery cooling device having a structure in which a pulsating heat pipe is inserted between battery cells to improve the heat dissipation performance of the battery cell is being used.

The above information disclosed in this background section is for understanding of the background of the present disclosure, and therefore it may contain information that may not be prior art.

### SUMMARY

The present disclosure addresses the problems associated with conventional battery cooling devices, and various aspects of the present disclosure are directed to providing a battery cooling device including a pulsating heat pipe, wherein the pulsating heat pipe is manufactured to have a structure in which a vertical channel performing a heat absorption function and a horizontal channel performing a condensation function form a T-shaped passage to increase the surface area of the horizontal channel, allowing the horizontal channel to be arranged below one of two battery cells, which are selected from battery cells stacked in a predetermined number and are stacked with a surface pressure pad disposed between the two battery cells, to thereby achieve (e.g., substantially) even cooling of (e.g., all) battery cells.

For example, the present disclosure provides a battery cooling device. The battery cooling device includes a pulsating heat pipe having a plurality of vertical channels and a plurality of horizontal channels formed inside the pulsating heat pipe to cool battery cells, wherein the vertical channels and the horizontal channels form a T-shaped passage that provide pulsatile refrigerant flow, and a cooling water channel arranged below the horizontal channels.

According to an example embodiment of the present disclosure, in the pulsating heat pipe, the vertical channel may be disposed between battery cells and be configured as an evaporator section that takes heat from each of the battery cells, and the horizontal channel may extend in opposite directions from a lower portion of the vertical channel so as to be arranged at a bottom of each of the battery cells and be configured as a condenser section that releases heat to the outside.

To this end, the pulsating heat pipe may be a four-piece assembled component in which the plurality of vertical channels and the plurality of horizontal channels are formed to be a T-shaped passage through which a refrigerant may flow.

Moreover, the pulsating heat pipe may include a vertical plate having one surface formed with the plurality of vertical channels, a sealing plate configured to seal the vertical channels by being attached to the one surface of the vertical plate, an intermediate horizontal plate having a structure in which a plurality of via holes configured to communicate with the vertical channels are formed, and being attached to a lower end portion of the vertical plate and to a lower end portion of the sealing plate, and a lower horizontal plate having an upper surface portion formed with the plurality of horizontal channels configured to communicate with the via holes, and being attached to a lower surface portion of the intermediate horizontal plate.

Moreover, the horizontal channel may include a first horizontal channel extending a predetermined distance in one direction from the via hole, and a second horizontal channel extending a predetermined distance in another direction from an end portion of the first horizontal channel. Here, the first horizontal channel and the second horizontal channel may be connected to each other to form a U-shaped passage on a same plane.

Moreover, the horizontal channel may further include a third horizontal channel extending from an end portion of the second horizontal channel to form a U-shaped passage on a same plane and being connected to another vertical channel.

Moreover, when the vertical plate and the intermediate horizontal plate are connected in a T-shaped arrangement, the vertical plate may be arranged between one battery cell and another battery cell in a closely contactable manner, and one upper surface portion of the intermediate horizontal plate may be brought into close contact with a lower surface portion of the one battery cell and another upper surface portion of the intermediate horizontal plate may be brought into close contact with a lower surface portion of the other battery cell.

According to another embodiment of the present disclosure, the pulsating heat pipe may be a five-piece assembled component in which the plurality of vertical channels and the plurality of horizontal channels are formed to be a T-shaped passage through which a refrigerant may flow.

To this end, the pulsating heat pipe may include a vertical plate having one surface formed with the plurality of vertical channels, a sealing plate configured to seal the vertical channels by being attached to the one surface of the vertical plate, an upper horizontal plate having a lower surface portion formed with a plurality of first horizontal channels configured to communicate with the vertical channels, and being attached to a lower end portion of the vertical plate and to a lower end portion of the sealing plate, an intermediate horizontal plate having a structure in which a plurality of via holes configured to communicate with the first horizontal channels are formed, and being attached to the lower surface portion of the upper horizontal plate, and a lower horizontal plate having an upper surface portion formed with a plurality of second horizontal channel configured to communicate with the via holes, and being attached to a lower surface portion of the intermediate horizontal plate.

Moreover, the first horizontal channel may extend in one direction from a lower portion of the vertical channel to the via hole, and the second horizontal channel may extend in another direction from the via hole by a predetermined length. Here, the first horizontal channel and the second horizontal channel may be arranged in a vertically overlapping manner.

Moreover, an end portion of the second horizontal channel may be connected to another second horizontal channel right next to the second horizontal channel to form a U-shaped passage.

Moreover, when the vertical plate and the upper horizontal plate are connected in a T-shaped arrangement, the vertical plate may be arranged between one battery cell and another battery cell in a closely contactable manner, and one upper surface portion of the upper horizontal plate may be brought into close contact with a lower surface portion of the one battery cell and another upper surface portion of the upper horizontal plate may be brought into close contact with a lower surface portion of the other battery cell.

Other aspects and embodiments of the present disclosure are discussed herein.

### BRIEF DESCRIPTION OF THE DRAWINGS

The above and other features of the present disclosure are described in detail with reference to example embodiments thereof illustrated in the accompanying drawings which are given herein below by way of illustration only, and thus are not limitative of the present disclosure, and wherein:

FIG. 1 is a schematic cross-sectional view illustrating a conventional battery cooling device;

FIG. 2 is a schematic cross-sectional view illustrating a battery cooling device according to the present disclosure;

FIG. 3 is an exploded perspective view illustrating a pulsating heat pipe of a battery cooling device according to an example embodiment of the present disclosure;

FIG. 4 is a cross-sectional view illustrating a pulsating heat pipe of a battery cooling device according to an example embodiment of the present disclosure;

FIG. 5 is an exploded schematic view illustrating a profile of a vertical channel and a horizontal channel formed inside a pulsating heat pipe according to an example embodiment of the present disclosure;

FIG. 6 is an exploded perspective view illustrating a pulsating heat pipe of a battery cooling device according to another example embodiment of the present disclosure;

FIG. 7 is a cross-sectional view illustrating a pulsating heat pipe of a battery cooling device according to another example embodiment of the present disclosure; and

FIG. 8 is an exploded schematic view illustrating a profile of a vertical channel and a horizontal channel formed inside a pulsating heat pipe according to another example embodiment of the present disclosure.

Appended drawings may not be necessarily to scale, presenting a somewhat simplified representation of various features of the present disclosure. The design features of the present disclosure, include, for example, specific dimensions, orientations, locations, and shapes, may be determined in part by the particular intended application and usage environment.

In the figures, the reference numbers refer to the same or similar parts of the present disclosure throughout several figures.

### DETAILED DESCRIPTION

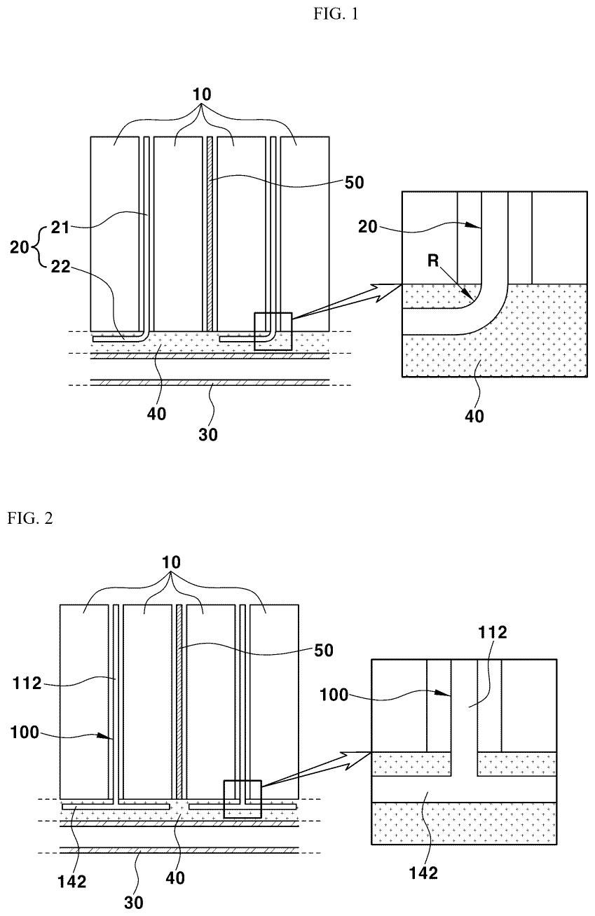

FIG. 1 is a schematic cross-sectional view illustrating a conventional battery cooling device.

As illustrated in FIG. 1, the conventional battery cooling device includes a pulsating heat pipe (PHP) 20 disposed between battery cells 10, and a cooling water channel 30 arranged adjacent to the bottom of the battery cell 10.

The pulsating heat pipe 20 has a hollow structure and is made of an aluminum (Al) or aluminum-copper (Al—Cu) alloy material with a sufficient thermal conductivity. The pulsating heat pipe 20 may be manufactured to have a (e.g., sealed) structure in which a refrigerant is configured to be injected to flow into the pulsating heat pipe 20 and then is sealed.

Because the pulsating heat pipe 20 is manufactured to have a structure in which a vertical pipe 21 and a horizontal pipe 22 are bent into an L-shape, the vertical pipe 21 is disposed between battery cells 10, and the horizontal pipe 22 is arranged below the battery cell 10 and is arranged adjacent to the cooling water channel 30.

For reference, the pulsating heat pipe 20 in FIG. 1 is illustrated to include one vertical pipe 21 and one horizontal pipe 22, but in effect, the pulsating heat pipe 20 may be manufactured such that a plurality of vertical pipes 21 and a plurality of horizontal pipes 22 form one refrigerant flow path and are connected to one another.

Here, between the bottom of the battery cell 10 and the horizontal pipe 22 and between the horizontal pipe 22 and the cooling water channel 30, a gap filler 40 may be applied to eliminate the clearance.

Particularly, in the pulsating heat pipe 20, the vertical pipe 21 serves as an evaporator section that takes heat from the battery cells 10, and the horizontal pipe 22 serves as a condenser section that releases heat to the outside.

Accordingly, heat is transferred from the battery cell 10 to the vertical pipe 21, and the horizontal pipe 22 is cooled by the outside air and the cooling water in the cooling water channel 30, causing a temperature difference between the vertical pipe 21, which is an evaporator section, and the horizontal pipe 22, which is a condenser section.

In addition, the vertical pipe 21 performs an evaporation function that absorbs heat from the battery cell 10 and the horizontal pipe 22 performs a condensation function that releases heat, causing a pressure difference between the vertical pipe 21 and the horizontal pipe 22.

Accordingly, due to the pressure difference between the vertical pipe 21 and the horizontal pipe 22, the refrigerant filling the vertical pipe 21 and the horizontal pipe 22 pulsates, and by the pulsation of the refrigerant, the heat transferred from the battery cell 10 is transferred from the vertical pipe 21, i.e., the evaporator section, to the horizontal pipe 22, i.e., the condenser section, and is released to the outside, facilitating the heat dissipation and cooling of the battery cell, and thus preventing overheating of the battery cell.

However, the conventional battery cooling device of FIG. 1 may be improved.

First, considering that the maximum performance of the pulsating heat pipe may be obtained as the temperature difference between the vertical pipe 21, i.e., the evaporator section, and the horizontal pipe 22, i.e., the condenser section, increases, the surface area of the vertical pipe 21 brought into contact with the battery cell 10 should be increased or the area of the horizontal pipe 22 adjacent to the cooling water channel 30 should be increased. However, because the areas of the side surface and lower surface portion of the battery cell 10 are predetermined by an arbitrary design, the surface areas of the vertical pipe 21 or the horizontal pipe 22 may not be increased.

Second, referring to FIG. 1, because a large gap is generated between the battery cell 10 and the horizontal pipe 22 due to the curvature R of the bent portion between the vertical pipe 21 and the horizontal pipe 22, a gap filler filling the gap is applied having (e.g., excessive) thickness.

Third, in a case where a surface pressure pad 50 exists between two battery cells selected from among the battery cells 10 stacked in a predetermined number, the horizontal pipe 22 may fail to be arranged below one of the two battery cells, resulting in a potential deterioration in the cooling performance of the battery cells.

For example, in a case where, as illustrated in FIG. 1, a surface pressure pad 50 to facilitate stacking of battery cells exists between a second battery cell 12 and a third battery cell 13, which are selected from among the battery cells 10 stacked in a predetermined number, a horizontal pipe 22, bent from a vertical pipe 21 disposed between a first battery cell 11 and the second battery cell 12, may be arranged below the first battery cell 11 but fails to be arranged below the second battery cell 12 and thus the first battery cell 11 and the second battery cell 12 are cooled differently, which leads to a decrease in cooling performance for the second battery cell 12 compared to the first battery cell 11, and eventually may fail to achieve even cooling of (e.g., all) battery cells 10.

Descriptions of specific structures or functions presented in the example embodiments of the present disclosure are for the purpose of explaining the example embodiments according to the present disclosure, and the example embodiments according to the present disclosure may be implemented in various forms. In addition, the descriptions should not be construed as limiting the example embodiments described herein, and should be understood to include modifications, equivalents and substitutes falling within the present disclosure.

The term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The terms “first”, “second”, etc. may be used to describe various components, but the components are not limited to the terms. These terms are used to distinguish one component from another. For example, a first component could be termed a second component, and similarly, a second component could be termed a first component, without departing from the scope of example embodiments of the present disclosure.

When a component is referred to as being “connected to” or “brought into contact with” another component, the component may be directly connected to or brought into contact with the other component, or intervening components may also be present. In contrast, when a component is referred to as being “directly connected to” or “brought into direct contact with” another component, there is no intervening component present. Other terms used to describe relationships between components may be interpreted in a similar manner (e.g., “between” versus “directly between,” “adjacent” versus “directly adjacent,” etc.).

Throughout the specification, like reference numerals indicate like components. The terminology used herein is for the purpose of illustrating embodiments and is not intended to limit the present disclosure. In this specification, the singular form includes plural forms unless specified otherwise. The terms “comprises” and/or “comprising” used in this specification mean that the cited component, step, operation, and/or element does not exclude the presence or addition of one or more of other components, steps, operations, and/or elements.

Hereinafter, various example embodiments of the present disclosure are described in detail with reference to the attached drawings.

FIG. 2 is a schematic cross-sectional view illustrating an example embodiment of a battery cooling device according to the present disclosure.

The battery cooling device according to the present disclosure includes, as illustrated in FIG. 2, a pulsating heat pipe (PHP) 100 disposed between and below battery cells 10, and a cooling water channel 30 arranged adjacent to the bottom of the battery cells 10.

The pulsating heat pipe 100 has a hollow structure and is made of an aluminum (Al) or aluminum-copper (Al—Cu) alloy material with a (e.g., sufficient) thermal conductivity. The pulsating heat pipe 100 may be manufactured to have a sealed structure in which a refrigerant is flowably injected into the pulsating heat pipe 100 and then is sealed.

For example, the pulsating heat pipe 100 has a structure in which a plurality of vertical channels 112 and a plurality of horizontal channels 142 are formed inside the pulsating heat pipe 100, wherein the vertical channels 112 and the horizontal channels 142 form a T-shaped passage.

For example, the plurality of vertical channels 112 are formed inside the pulsating heat pipe 100, and the horizontal channels 142 each extend in one direction and another direction from the lower portion of each of the corresponding vertical channels 112 to form a T-shaped passage that provides (e.g., enables) pulsatile refrigerant flow.

In the pulsating heat pipe 100, the vertical channel 112 is disposed between battery cells 10 and serves as an evaporator section that takes heat from each of the battery cells 10, and the horizontal channel 142 is arranged at the bottom of each of the battery cells 10 and serves as a condenser section that releases heat to the outside.

When the vertical channel 112 and the horizontal channel 142 are connected in a T-shaped arrangement, the vertical channel 112 is disposed between one battery cell 10 and another battery cell 10 in a (e.g., closely) contactable manner. Here, one upper surface portion of the horizontal channel 142 extended in one direction from the lower portion of the vertical channel 112 may be brought into (e.g., close) contact with the lower surface portion of the one battery cell 10, and another upper surface portion of the horizontal channel 142 extended in another direction from the lower portion of the vertical channel 112 may be brought into (e.g., close) contact with the lower surface portion of the other battery cell 10.

Meanwhile, the cooling water channel 30 is arranged under the horizontal channel 142. Here, cooling water for heat exchange with the horizontal channel 142 and the refrigerant in the horizontal channel 142 may be circulated inside the cooling water channel 30.

Accordingly, heat is transferred from the battery cell 10 to the vertical channel 112, and the horizontal channel 142 is cooled by the outside air and the cooling water in the cooling water channel 30, causing a temperature difference between the vertical channel 112, which is an evaporator section, and the horizontal channel 142, which is a condenser section.

In addition, the vertical channel 112 performs an evaporation function that absorbs heat from the battery cell 10 and the horizontal channel 142 performs a condensation function that releases heat, causing a pressure difference between the vertical channel 112 and the horizontal channel 142.

Accordingly, due to the pressure difference between the vertical channel 112 and the horizontal channel 142, the refrigerant filling the vertical channel 112 and the horizontal channel 142 pulsates, and by the pulsation of the refrigerant, the heat transferred from the battery cell 10 is transferred from the vertical channel 112, i.e., the evaporator section, to the horizontal channel 142, i.e., the condenser section, and is released to the outside, facilitating the heat dissipation and cooling of the battery cell, and thus preventing overheating of the battery cell.

As such, by manufacturing the pulsating heat pipe 100 to have a structure in which the vertical channel 112 performing the heat absorption function and the horizontal channel 142 performing the condensation function form the T-shaped passage to thereby provide the horizontal channel 142 with an increased heat exchange surface area (e.g., as compared to the horizontal pipe in the conventional pulsating heat pipe of FIG. 1), increasing the surface area of the horizontal channel 142 to be brought into contact with the cooling water channel 30 and increasing the temperature difference between the vertical channel 112 and the horizontal channel 142 through which the refrigerant flows, thereby improves the battery cooling performance of the pulsating heat pipe 100.

Furthermore, by providing (e.g., allowing), as illustrated in FIG. 2, the horizontal channel 142 to be arranged at the bottom of each of battery cells 10, even in the case where a surface pressure pad 50 to facilitate stacking of battery cells exists between a second battery cell 12 and a third battery cell 13, which are selected from among the battery cells 10 stacked in a predetermined number, the battery cell cooling performance by the pulsating heat pipe 100 may be improved, by achieving (e.g., substantially) even cooling of (e.g., all) battery cells 10.

Hereinafter, a pulsating heat pipe of a battery cooling device according to an example embodiment of the present disclosure and the function of the pulsating heat pipe are described.

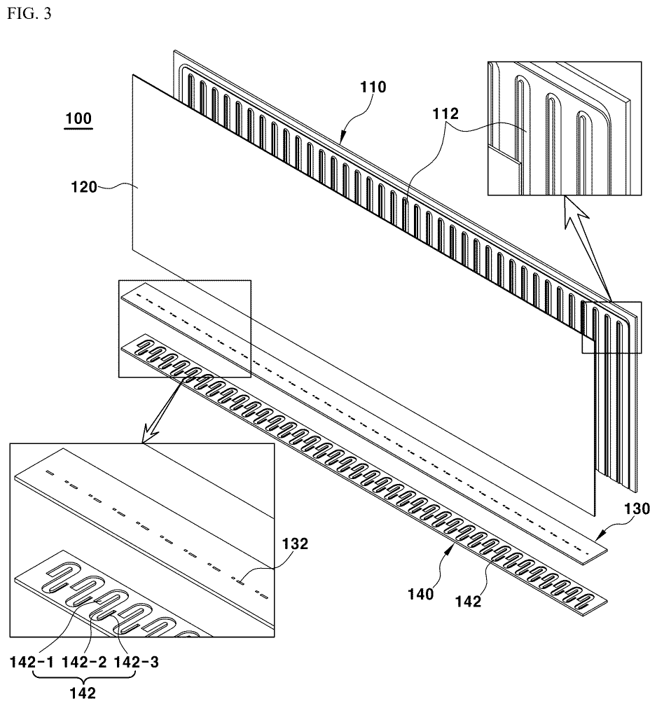

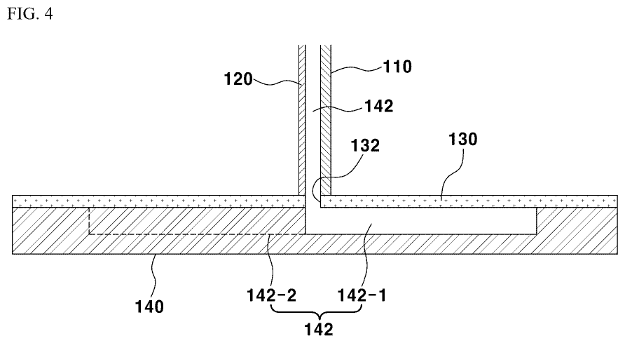

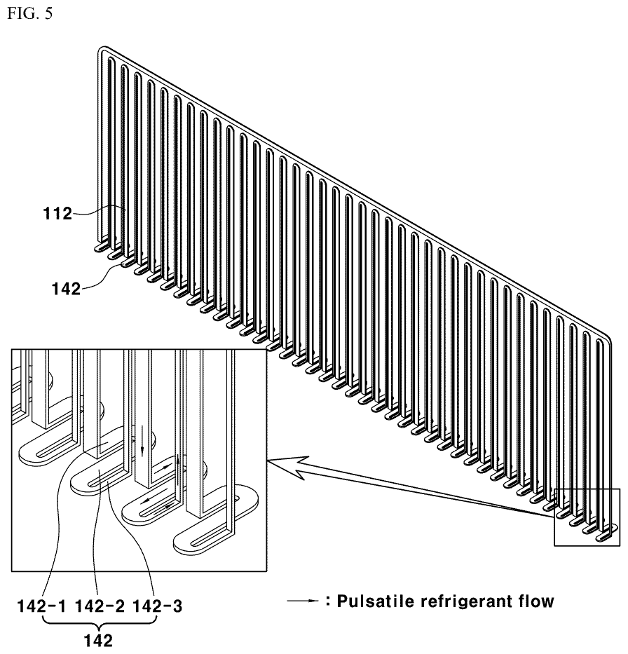

FIG. 3 is an exploded perspective view illustrating the pulsating heat pipe of the battery cooling device according to an example embodiment of the present disclosure, FIG. 4 is a cross-sectional view illustrating the pulsating heat pipe of the battery cooling device according to an example embodiment of the present disclosure, and FIG. 5 is an exploded schematic view illustrating a profile of a vertical channel and a horizontal channel formed inside the pulsating heat pipe according to an example embodiment of the present disclosure.

A pulsating heat pipe 100 according to an example embodiment of the present disclosure may be manufactured as a four-piece assembled component in which a plurality of vertical channels and a plurality of horizontal channels are formed to be a T-shaped passage through which a refrigerant may flow.

The pulsating heat pipe 100 according to an example embodiment of the present disclosure may be manufactured as a four-piece component, including a vertical plate 110 having a (e.g., one) surface formed with the plurality of vertical channels 112, a sealing plate 120, an intermediate horizontal plate 130, and a lower horizontal plate 140 having an upper surface portion formed with the plurality of horizontal channels 142, as illustrated in FIGS. 3 and 4.

The vertical plate 110 has the (e.g., one) surface formed with the plurality of vertical channels 112, wherein the vertical channels 112 extend in an up-down direction at predetermined intervals in a width direction, and the lower portion of each of the vertical channels 112 is open.

The sealing plate 120 serves to seal the plurality of vertical channels 112 by being brazed to the (e.g., one) surface of the vertical plate 110.

When the sealing plate 120 is brazed to the (e.g., one) surface of the vertical plate 110, the plurality of vertical channels 112 formed in the (e.g., one) surface of the vertical plate 110 may be sealed respectively.

The intermediate horizontal plate 130 has a plurality of via holes 132 formed therein. Each of the plurality of via holes 132 is configured to communicate with the open lower portion of a corresponding one of the vertical channels 112. The intermediate horizontal plate 130 is brazed to a lower end portion of the vertical plate 110 and to a lower end portion of the sealing plate 120.

The lower horizontal plate 140 has the upper surface portion formed with the plurality of horizontal channels 142. Each of the plurality of horizontal channels 142 is configured to communicate with a corresponding one of the via holes 132. The lower horizontal plate 140 is brazed to a lower surface portion of the intermediate horizontal plate 130.

For example, the horizontal channel 142 formed in the lower horizontal plate 140 includes, as illustrated in FIG. 5, a first horizontal channel 142-1 extending a predetermined distance in one direction from the via hole 132 in the intermediate horizontal plate 130, and a second horizontal channel 142-2 extending a predetermined distance in another direction from an end portion of the first horizontal channel 142-1.

As shown, the first horizontal channel 142-1 and the second horizontal channel 142-2 are (e.g., communicably) connected to each other to form a U-shaped passage on a (e.g., shared) same plane.

The horizontal channel 142 further includes a third horizontal channel 142-3 extending from an end portion of the second horizontal channel 142-2 to form a U-shaped passage on the (e.g., shared) same plane. Here, the third horizontal channel 142-3 is connected to another vertical channel 142 to circulate the refrigerant to the other vertical channel 142.

When the vertical plate 110 and the intermediate horizontal plate 130 are connected in a T-shaped arrangement as described above, the vertical plate 110 may be, as illustrated in FIG. 4, arranged between one (e.g., a first) battery cell 10 and another (e.g., a second) battery cell 10 in a (e.g., closely) contactable manner, and, with the vertical plate 110 as a boundary between the battery cells 10, one upper surface portion of the intermediate horizontal plate 130 may be brought into (e.g., close) contact with a lower surface portion of the one battery cell 10 and another upper surface portion of the intermediate horizontal plate 130 may be brought into (e.g., close) contact with a lower surface portion of the other battery cell 10.

Accordingly, heat is transferred from the battery cell 10 to the vertical channel 112, and the horizontal channel 142 is cooled by the outside air and the cooling water in the cooling water channel 30, causing a temperature difference between the vertical channel 112, i.e., the evaporator section, and the horizontal channel 142, i.e., the condenser section.

In addition, the vertical channel 112 in the vertical plate 110 performs an evaporation function that absorbs heat from the battery cell 10, and the horizontal channel 142 including the first horizontal channel 142-1, the second horizontal channel 142-2, and the like in the lower horizontal plate 140 performs a condensation function that releases heat, causing a pressure difference between the vertical channel 112 and the horizontal channel 142.

Thereafter, due to the pressure difference between the vertical channel 112 and the horizontal channel 142, the refrigerant filling the vertical channel 112 and the horizontal channel 142 pulsates, generating a flow of the refrigerant circulating from the vertical channel 112 through the first horizontal channel 142-1, the second horizontal channel 142-2, and the third horizontal channel 142-3 in sequence, and then to another vertical channel 112, as indicated by the arrows in FIG. 5.

By the pulsatile refrigerant flow, the heat transferred from the battery cell 10 is transferred from the vertical channel 112, i.e., the evaporator section, to the horizontal channel 142, i.e., the condenser section, and is released to the outside, facilitating the heat dissipation and cooling of the battery cell, and thus preventing overheating of the battery cell.

Hereinafter, a pulsating heat pipe of a battery cooling device according to another example embodiment of the present disclosure and the function of the pulsating heat pipe are described.

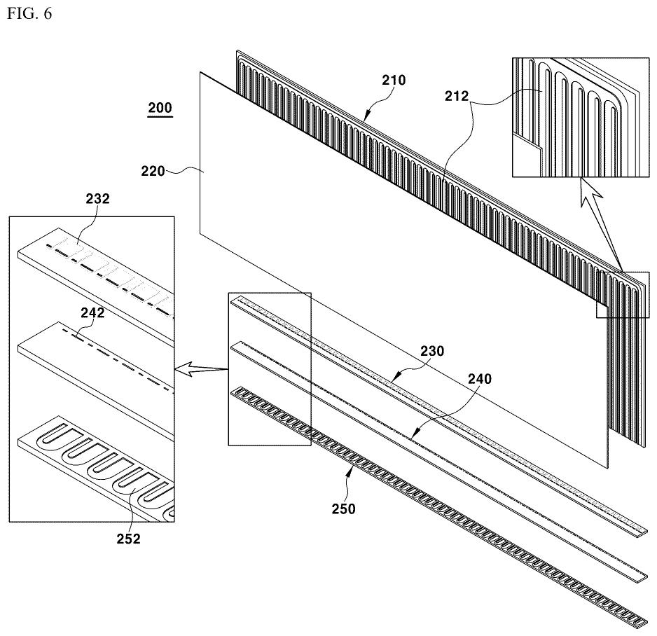

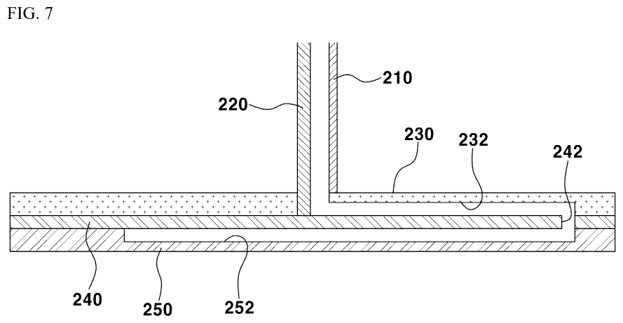

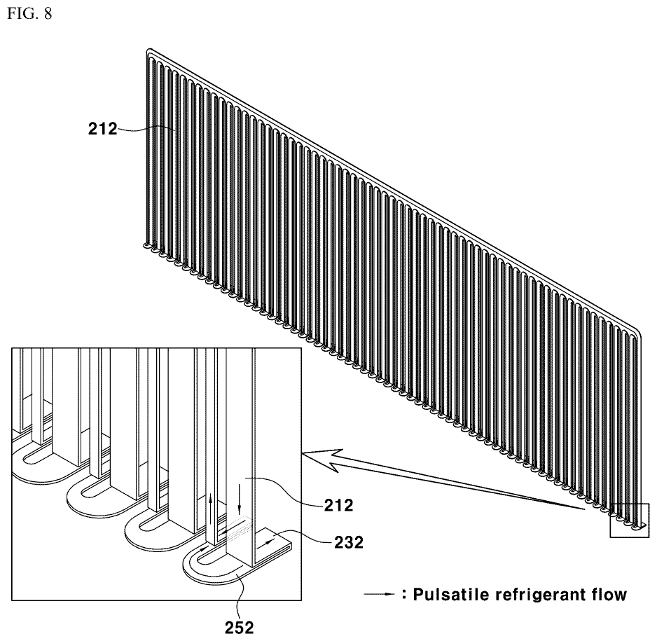

FIG. 6 is an exploded perspective view illustrating a pulsating heat pipe of a battery cooling device according to another example embodiment of the present disclosure, FIG. 7 is a cross-sectional view illustrating a pulsating heat pipe of a battery cooling device according to another example embodiment of the present disclosure, and FIG. 8 is an exploded schematic view illustrating a profile of a vertical channel and a horizontal channel formed inside a pulsating heat pipe according to another example embodiment of the present disclosure.

A pulsating heat pipe 200 according to another example embodiment of the present disclosure may be manufactured as a five-piece assembled component in which a plurality of vertical channels and a plurality of horizontal channels are formed to be a T-shaped passage through which a refrigerant may flow.

The pulsating heat pipe 200 according to the example embodiment of the present disclosure, shown in FIGS. 6-8, may be manufactured as a five-piece component, including a vertical plate 210 having a (e.g., one) surface formed with a plurality of vertical channels 212, a sealing plate 220, an upper horizontal plate 230 having a lower surface portion formed with a first horizontal channel 232, an intermediate horizontal plate 240, and a lower horizontal plate 250 having an upper surface portion formed with a second horizontal channel 252, as illustrated in FIGS. 6 and 7.

The vertical plate 210 has the (e.g., one) surface formed with the plurality of vertical channels 212, wherein the vertical channels 212 extend in an up-down direction at predetermined intervals in a width direction, and the lower portion of each of the vertical channels 212 is open.

The sealing plate 220 serves to seal the plurality of vertical channels 212 by being brazed to the one surface of the vertical plate 210.

For example, when the sealing plate 220 is brazed to the one surface of the vertical plate 210, the plurality of vertical channels 212 formed in the one surface of the vertical plate 210 may be sealed respectively.

The upper horizontal plate 230 has a lower surface portion formed with a plurality of first horizontal channels 232 each configured to communicate with a lower portion of a corresponding one of the vertical channels 212. The upper horizontal plate 230 is brazed to a lower end portion of the vertical plate 210 and to a lower end portion of the sealing plate 220.

The intermediate horizontal plate 240 has formed therein a plurality of via holes 242 each configured to communicate with a corresponding one of the first horizontal channels 232. The intermediate horizontal plate 240 is brazed to the lower surface portion of the upper horizontal plate 230.

The lower horizontal plate 250 has formed therein a plurality of second horizontal channels 252 each configured to communicate with a corresponding one of the via holes 242. The lower horizontal plate 250 is brazed to a lower surface portion of the intermediate horizontal plate 240.

As illustrated in FIG. 8, the first horizontal channel 232 formed in the lower surface portion of the upper horizontal plate 230 extends in one direction from the lower portion of the vertical channel 212 to the via hole 242, and the second horizontal channel 252 formed in the upper surface portion of the lower horizontal plate 250 extends in another direction from the via hole 242 by a predetermined length, so that the first horizontal channel 232 and the second horizontal channel 252 form a vertically overlapping arrangement.

Moreover, an end portion of the second horizontal channel 252 is (e.g., communicably) connected to another second horizontal channel 252 (e.g., right) next to the second horizontal channel 252 to form a U-shaped passage on a (e.g., shared) same plane.

When the vertical plate 210 and the upper horizontal plate 230 are connected in a T-shaped arrangement as described above, the vertical plate 210 may be, as illustrated in FIG. 7, arranged between one battery cell 10 and another battery cell 10 in a (e.g., closely) contactable manner, and, with the vertical plate 210 as a boundary between the battery cells 10, one upper surface portion of the upper horizontal plate 230 may be brought into (e.g., close) contact with a lower surface portion of the one battery cell 10 and another upper surface portion of the upper horizontal plate 230 may be brought into (e.g., close) contact with a lower surface portion of the other battery cell 10.

Accordingly, heat is transferred from the battery cell 10 to the vertical channel 212, and the first horizontal channel 232 and the second horizontal channel 252 are cooled by the outside air and the cooling water in the cooling water channel 30, causing a temperature difference between the vertical channel 212, which is the evaporator section, and the first horizontal channel 232 and the second horizontal channel 252, which are the condenser section.

In addition, the vertical channel 212 in the vertical plate 210 performs an evaporation function that absorbs heat from the battery cell 10, and the first horizontal channel 232 in the upper horizontal plate 230 and the second horizontal channel 252 in the lower horizontal plate 250 perform a condensation function that releases heat, causing a pressure difference between the vertical channel 212, i.e., the evaporator section. and the first horizontal channel 232 and second horizontal channel 252, i.e., the condenser section.

Thereafter, due to the difference between the internal pressure of the vertical channel 212 and the internal pressure of the first horizontal channel 232 and second horizontal channel 252, the refrigerant filling the vertical channel 212, first horizontal channel 232, and second horizontal channel 252 pulsates, generating a flow of the refrigerant circulating from the vertical channel 212 through the first horizontal channel 232 and the second horizontal channel 252 (e.g., in sequence), and then to another vertical channel 212, as indicated by the arrows in FIG. 8.

By the pulsatile refrigerant flow, the heat transferred from the battery cell 10 is transferred from the vertical channel 212, i.e., the evaporator section, to the first horizontal channel 232 and second horizontal channel 252, i.e., the condenser section, and is released to the outside, facilitating the heat dissipation and cooling of the battery cell, and thus preventing overheating of the battery cell.

The present disclosure provides at least the following improvements.

First, by manufacturing a pulsating heat pipe to have a structure in which a vertical channel performing a heat absorption function and a horizontal channel performing a condensation function form a T-shaped passage to thereby provide a horizontal channel with an increased heat exchange surface area as compared to the horizontal pipe in the pulsating heat pipe of the conventional battery cooling device, increasing the temperature difference between the vertical channel and the horizontal channel through which a refrigerant flows, and thus improving the battery cooling performance of the pulsating heat pipe.

Second, by manufacturing the pulsating heat pipe to have a structure in which a vertical channel disposed between battery cells and a horizontal channel arranged below the battery cells form a T-shaped passage to increase the surface area of the horizontal channel for indirect contact with a cooling water channel, increasing the heat dissipation performance of the horizontal channel, and thus improving the battery heat dissipation and cooling performance of the pulsating heat pipe.

Third, by providing the horizontal channel (e.g., to be arranged) below each of two battery cells even in a case where a surface pressure pad exists between the two battery cells selected from among battery cells stacked in a predetermined number, the battery cell cooling performance by the pulsating heat pipe may be improved.

Although the present disclosure has been described in detail with reference to example embodiments, the scope of the present disclosure is not limited to the above-described example embodiments, and various modifications and improvements by those skilled in the art based on the present disclosure as provided in the claims will also be included in the scope of the present disclosure.

What is claimed is:

1. A battery cooling device, comprising:
a pulsating heat pipe including a plurality of vertical channels and a plurality of horizontal channels configured to cool a plurality of battery cells, wherein the vertical channels and the horizontal channels form a T-shaped passage configured to pulsatile refrigerant flow; and
a cooling water channel arranged below the horizontal channels.

2. The battery cooling device of claim 1, wherein, in the pulsating heat pipe, at least one vertical channel is disposed between the plurality of battery cells and is configured as an evaporator section that is configured to remove heat from each of the plurality of battery cells.

3. The battery cooling device of claim 2, wherein, in the pulsating heat pipe, at least one horizontal channel extends in a direction opposite a lower portion of the at least one vertical channel.

4. The battery cooling device of claim 3, wherein the at least one horizontal channel is extends along a bottom of each battery cell of the plurality of the battery cells and is configured as a condenser section that is configured to release heat to outside.

5. The battery cooling device of claim 1, wherein the pulsating heat pipe is a four-piece assembly forming the T-shaped passage, wherein a refrigerant is configured to flow through the pulsating heat pipe.

6. The battery cooling device of claim 5, wherein the pulsating heat pipe comprises:
a vertical plate having a first surface formed with the plurality of vertical channels; and
a sealing plate configured to seal the plurality of vertical channels, wherein the sealing plate is coupled to the first surface of the vertical plate.

7. The battery cooling device of claim 6, wherein the pulsating heat pipe further comprises:
an intermediate horizontal plate including a plurality of via holes configured to communicate with the plurality of vertical channels, and coupled to a lower end portion of the vertical plate and to a lower end portion of the sealing plate.

8. The battery cooling device of claim 7, wherein the pulsating heat pipe further comprises:
a lower horizontal plate including an upper surface portion formed with the plurality of horizontal channels configured to communicate with the via holes, and coupled to a lower surface portion of the intermediate horizontal plate.

9. The battery cooling device of claim 7, wherein at least one horizontal channel comprises a first horizontal channel extending a predetermined distance in a first direction from the via hole, and a second horizontal channel extending a predetermined distance in a second direction from an end portion of the first horizontal channel.

10. The battery cooling device of claim 9, wherein the first horizontal channel and the second horizontal channel are coupled to form a U-shaped passage on a shared plane.

11. The battery cooling device of claim 10, wherein the horizontal channel further comprises a third horizontal channel extending from an end portion of the second horizontal channel to form a U-shaped passage on the shared plane and coupled to another at least one vertical channel.

12. The battery cooling device of claim 7, wherein, when the vertical plate and the intermediate horizontal plate are coupled in a T-shaped arrangement, the vertical plate is arranged between a first battery cell and a second battery cell.

13. The battery cooling device of claim 12, wherein, when the vertical plate and the intermediate horizontal plate are coupled in the T-shaped arrangement, a first upper surface portion of the intermediate horizontal plate is configured to contact a lower surface portion of the first battery cell and a second upper surface portion of the intermediate horizontal plate is configured to contact a lower surface portion of the second battery cell.

14. The battery cooling device of claim 1, wherein the pulsating heat pipe is a five-piece assembly forming the T-shaped passage, wherein a refrigerant is configured to flow through the T-shaped passage.

15. The battery cooling device of claim 14, wherein the pulsating heat pipe comprises:
a vertical plate having a first surface formed with the plurality of vertical channels;
a sealing plate configured to seal the plurality of vertical channels, wherein the sealing plate is coupled to the first surface of the vertical plate;
an upper horizontal plate having a lower surface portion formed with a plurality of first horizontal channels configured to communicate with the vertical channels, and being attached to a lower end portion of the vertical plate and to a lower end portion of the sealing plate;
an intermediate horizontal plate including a plurality of via holes configured to communicate with the first horizontal channels, and coupled to the lower surface portion of the upper horizontal plate; and
a lower horizontal plate including an upper surface portion formed with a plurality of second horizontal channel configured to communicate with the via holes, and coupled to a lower surface portion of the intermediate horizontal plate.

16. The battery cooling device of claim 15, wherein the first horizontal channel extends in a first direction from a lower portion of the vertical channel to the via hole, and the second horizontal channel extends a predetermined length in a second direction from the via hole.

17. The battery cooling device of claim 16, wherein the first horizontal channel and the second horizontal channel are configured to vertically overlap.

18. The battery cooling device of claim 15, wherein an end portion of the second horizontal channel is coupled to another second horizontal channel next to the second horizontal channel to form a U-shaped passage.

19. The battery cooling device of claim 15, wherein, when the vertical plate and the upper horizontal plate are coupled in a T-shaped arrangement, the vertical plate is coupled between a first battery cell and a second battery cell.

20. The battery cooling device of claim 19, wherein, when the vertical plate and the upper horizontal plate are coupled in the T-shaped arrangement, a first upper surface portion of the upper horizontal plate contacts a lower surface portion of the first battery cell and a second upper surface portion of the upper horizontal plate contacts a lower surface portion of the second battery cell.
